(19) United States
(12) Patent Application Publication
(10) Pub. No.: US 2023/0222549 A1
(43) Pub. Date: Jul. 13, 2023

(54) INFORMATION PROVIDING METHOD, CONTROL METHOD, COMMUNICATION TERMINAL, AND RECORDING MEDIUM

(71) Applicant: Panasonic Intellectual Property Management Co., Ltd., Osaka (JP)

(72) Inventors: HIROSHI YAHATA, Osaka (JP); TAKAHIRO NISHI, Nara (JP); TADAMASA TOMA, Osaka (JP); TOSHIYASU SUGIO, Osaka (JP)

(21) Appl. No.: 18/051,905

(22) Filed: Nov. 2, 2022

Related U.S. Application Data
(63) Continuation of application No. PCT/JP2020/047895, filed on Dec. 22, 2020.

(30) Foreign Application Priority Data
May 21, 2020 (JP) 2020-088983

(51) Int. Cl. G06Q 30/0251

(52) U.S. Cl. CPC G06Q 30/0264; G06Q 30/0259; G06Q 30/0267

(57) ABSTRACT

A method includes: acquiring, from a first communication terminal of a first user via a network, i) a request for an advertisement corresponding to a store and ii) a first notification indicating that a beacon signal including a device identifier (ID) specifying a beacon signal transmitter disposed in the store has been received from the beacon signal transmitter; generating, based on limited product information, the request for the advertisement, and the first notification, privileged advertisement information; and outputting the privileged advertisement information to the first communication terminal.

### BACKGROUND

### 1. Technical Field

The present disclosure relates to a store management system connected to a store terminal.

### 2. Description of the Related Art

In recent years, there has been proposed a service for notifying an advertisement from a store to a mobile terminal of a user in the store. For example, Japanese Unexamined Patent Publication No. 2017-37574 discloses an advertisement providing system for realizing push notifications of advertisements at a frequency appropriate for a user and capable of maintaining advertisement effects.

### SUMMARY

However, there has been a need for further improvement in Japanese Unexamined Patent Publication No. 2017-37574.

In one general aspect, the techniques disclosed here feature a method for a store management system connected to a store terminal, the method including: acquiring, from the store terminal via a network, limited product information indicating a limited product for which a time available for sale in a store corresponding to the store terminal is limited; acquiring, from a first communication terminal of a first user via the network, i) a request for an advertisement corresponding to the store and ii) a first notification indicating that a beacon signal including a device identifier (ID) specifying a beacon signal transmitter disposed in the store has been received from the beacon signal transmitter, the beacon signal being received by the first communication terminal within a reception range of the beacon signal, the store being specified based on the device ID by the first communication terminal having received the beacon signal; generating, based on the limited product information, the request for the advertisement, and the first notification, privileged advertisement information of the store, the privileged advertisement information including the limited product; and outputting the privileged advertisement information to the first communication terminal.

According to the present disclosure, further improvement can be achieved.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of an overall configuration of an information providing system according to a first embodiment;

FIG. 2 is a block diagram illustrating an example of a detailed configuration of the information providing system according to the first embodiment;

FIG. 3 is an explanatory diagram relating to a beacon signal;

FIG. 4 is a diagram illustrating an example of a data configuration of a store dictionary;

FIG. 5 is a diagram illustrating an example of the data configuration of the store dictionary;

FIG. 6 is a sequence diagram illustrating an example of a process performed by the information providing system according to the first embodiment;

FIG. 7 is a sequence diagram illustrating an example of the process performed by the information providing system according to the first embodiment;

FIG. 8 is a diagram illustrating an example of an initial screen of a business operator X application;

FIG. 9 is a diagram illustrating an example of a map screen;

FIG. 10 is a screen diagram illustrating an example of a standard advertisement;

FIG. 11 is a screen diagram illustrating an example of a privileged advertisement;

FIG. 12 is a diagram illustrating an example of an advertisement screen displayed on a display device;

FIG. 13 is a flowchart illustrating details of the process performed by the information providing system according to the first embodiment;

FIG. 14 is a sequence diagram illustrating an example of a process performed by an information providing system according to a second embodiment;

FIG. 15 is a sequence diagram illustrating an example of the process performed by the information providing system according to the second embodiment; and

FIG. 16 is a sequence diagram illustrating an example of a process performed by an information providing system according to a third embodiment.

### DETAILED DESCRIPTIONS

### Underlying Knowledge Forming Basis of the Present Disclosure

In a store, a limited product for which a remaining time during which the product can be sold or a time slot during which the product can be sold (hereinafter, referred to as “time available for sale”) is limited may be present. For example, in a supermarket, there are cases where unsold products are sold at a special price immediately before the closing of the store, or foods specially delivered on the day are sold at a special price during a limited sales time slot.

In addition, some supermarkets provide a service of receiving an order from a user via a mobile terminal from outside the store and providing a freshly cooked fool such as delicatessen or packed meal to the user when the user visits the store. Even in a case where the user cancels the food after ordering it, if such a food is sold at a special price as a limited product without being discarded, food waste can be expected to be prevented.

Japanese Unexamined Patent Publication No. 2017-37574 discloses that a push notification of an advertisement is displayed on a display of an information terminal that has received a beacon signal from a store. However, in Japanese Unexamined Patent Publication No. 2017-37574, the advertisement displayed on the display of the information terminal is merely an electronic advertisement of a paper medium, and there is room for further improvement in notifying the limited product.

Japanese Unexamined Patent Publication No. 2017-37574 further discloses that a push notification of an advertisement is displayed on a display of an information terminal on condition that a notification waiting time has elapsed after a user carrying the information terminal enters a shopping mall. However, in Japanese Unexamined Patent Publication No. 2017-37574, the user is not notified of the advertisement unless the notification waiting time has elapsed after the user entered the shopping mall. Therefore, it is not possible to timely notify the user of the limited product, and there is room for further improvement.

Based on the above findings, the present inventors have conceived the following aspects according to the present disclosure.

A method according to an aspect of the present disclosure is a method for a store management system connected to a store terminal, the information providing method including: acquiring, from the store terminal via a network, limited product information indicating a limited product for which a time available for sale in a store corresponding to the store terminal is limited; acquiring, from a first communication terminal of a first user via the network, i) a request for an advertisement corresponding to the store and ii) a first notification indicating that a beacon signal including a device identifier (ID) specifying a beacon signal transmitter disposed in the store has been received from the beacon signal transmitter, the beacon signal being received by the first communication terminal within a reception range of the beacon signal, the store being specified based on the device ID by the first communication terminal having received the beacon signal; generating, based on the limited product information, the request for the advertisement, and the first notification, privileged advertisement information of the store, the privileged advertisement information including the limited product; and outputting the privileged advertisement information to the first communication terminal.

According to this configuration, the limited product information indicating the limited product for which the time available for sale is limited is acquired via the network, and a privileged advertisement including the limited product is displayed to a person who is within the reception range of the beacon signal from the store.

Thus, for example, it is possible to timely provide information about the limited product, which changes from moment to moment depending on stock or time, to a person in the store or in the vicinity of the store through the first communication terminal.

According to the present disclosure, the following effects are obtained when the limited product is a food whose commercial value significantly decreases with time, for example, a packed meal immediately before the best-before date.

That is, it is possible to reduce the food loss of foods provided by the store by displaying the advertisement including the limited product via the first communication terminal to a person who is in the vicinity of the store, who is likely to promptly pick up the limited product, and who is within the reception range of the beacon signal from the store. When the limited product is inexpensive, the user can obtain the limited product at a low price.

Furthermore, according to this configuration, the advertisement information is generated in response to the request for the advertisement corresponding to the store from the first user and is output to the first communication terminal. Therefore, the advertisement is prevented from being displayed on the first communication terminal against the will of the user, and the user can be prevented from being bothered.

In this configuration, the request for the advertisement corresponding to the store described in i) and the first notification indicating that the beacon signal including the device ID specifying the beacon signal transmitter disposed in the store has been received from the beacon signal transmitter described in ii) do not necessarily need to be divided into two. For example, i) and ii) may be indicated by specific information indicating that, in a case where the store has the limited product in stock, it is desired to transmit the privileged advertisement information including the limited product to the first communication terminal.

The method may further include: acquiring, from the store terminal, sold-out information indicating that the limited product has been sold out in the store; acquiring, from a second communication terminal of a second user, i) a request for the advertisement corresponding to the store and ii) a second notification indicating that the beacon signal including the device ID specifying the beacon signal transmitter disposed in the store has been received from the beacon signal transmitter, the beacon signal being received by the second communication terminal within the reception range of the beacon signal, the store being specified based on the device ID by the second communication terminal having received the beacon signal; and outputting, based on the sold-out information, the request for the advertisement, and the second notification, standard advertisement information of the store to the second communication terminal, the standard advertisement information not including the limited product.

According to this configuration, in response to the request for the advertisement from a user in the vicinity of the store or a user in the store, if the limited product is sold out, an advertisement not including the limited product is displayed. Therefore, it is possible to prevent the privileged advertisement from being displayed even if the limited product is sold out.

The method may further include: acquiring, from a third communication terminal of a third user, a request for the advertisement corresponding to the store, the third communication terminal being not within the reception range of the beacon signal; and outputting, based on the limited product information and the request for the advertisement, standard advertisement information of the store to the third communication terminal, the standard advertisement information not including the limited product.

In recent years, since an environment in which various products can be purchased via the Internet has been established, opportunities for users to visit real stores have been reduced.

With this configuration, when information is provided through the communication terminal, it is possible to distinguish between a person who actually visits the store and a person who does not visit the store, provide special information to the person who actually visits the store, and not provide the special information to the person who does not visit the store. Thus, it is possible to motivate a user to visit a real store by intentionally providing a border in the Web, which is a borderless world.

Note that Japanese Unexamined Patent Publication No. 2017-37574 describes that an advertisement is displayed on an information terminal that has received a beacon signal from a store, but does not describe how an advertisement about the store is displayed on an information terminal that does not receive the beacon signal from the store. Therefore, Japanese Unexamined Patent Publication No. 2017-37574 does not produce the above-mentioned effects.

In the method, a monitor connected to the store terminal may be disposed in the store, and the limited product information may be acquired from the store terminal in synchronization with a first instruction to display on the monitor the limited product information. The first instruction is output from the store terminal to the monitor.

According to this configuration, when the limited product information is notified through the monitor in the store, it is possible to cause the store management system to promptly acquire the limited product information, and it is possible to prevent occurrence of a time lag regarding acquisition of the limited product information in the store terminal and the store management system.

In the method, a monitor connected to the store terminal may be disposed in the store, and the sold-out information may be acquired from the store terminal in synchronization with a second instruction to erase a display of the limited product information from the monitor. The second instruction is output from the store terminal to the monitor.

According to this configuration, when the limited product information is deleted from the monitor in the store, it is possible to promptly notify this to the store management system, and it is possible to prevent occurrence of a time lag regarding deletion of the limited product information in the store terminal and the store management system.

In the method, the time available for sale may be shorter than 24 hours.

According to this configuration, it is possible to prevent a product whose freshness is degraded from being handled as a limited product.

A method according to another aspect of the present disclosure is a method for a store management system connected to a store terminal, the information providing method including: acquiring, from the store terminal via a network, limited product information indicating a limited product for which a time available for sale in a store corresponding to the store terminal is limited; acquiring, from a first communication terminal of a first user via the network, i) a request for an advertisement corresponding to the store and ii) a first notification indicating that a beacon signal including a device ID specifying a beacon signal transmitter disposed in the store has been received from the beacon signal transmitter, the beacon signal being received by the first communication terminal within a reception range of the beacon signal, the store being specified based on the device ID by the first communication terminal having received the beacon signal; generating, based on the limited product information, privileged advertisement information of the store, the privileged advertisement information including the limited product; and outputting, based on the request for the advertisement and the first notification, the privileged advertisement information to the first communication terminal.

According to this configuration, the limited product information indicating the limited product for which the time available for sale is limited is acquired via the network, and an advertisement including the limited product is displayed to a person who is within the reception range of the beacon signal from the store.

Thus, for example, it is possible to timely provide information about the limited product, which changes from moment to moment depending on stock or time, to a person in the store or in the vicinity of the store through the information terminal.

Furthermore, according to this configuration, the advertisement information is generated in response to the request for the advertisement corresponding to the store from the first user and is output to the first communication terminal. Therefore, the advertisement is prevented from being displayed on the first communication terminal against the will of the user, and the user can be prevented from being bothered.

Furthermore, according to this configuration, it is possible to generate the privileged advance information in advance based on the limited product information, and output the privileged advertisement information based on the request for the advertisement and the first notification. For this reason, the privileged advertisement information can be created at one time, and it is possible to save the time and effort to create the privileged advertisement information.

Also in this configuration, as described above, the request for the advertisement described in i) and the first notification described in ii) do not necessarily need to be divided into two.

The method may further include: acquiring, from the store terminal, sold-out information indicating that the limited product has been sold out in the store; acquiring, from a second communication terminal of a second user, i) a request for the advertisement corresponding to the store and ii) a second notification indicating that the beacon signal including the device ID specifying the beacon signal transmitter disposed in the store has been received from the beacon signal transmitter, the beacon signal being received by the second communication terminal within the reception range of the beacon signal, the store being specified based on the device ID by the second communication terminal having received the beacon signal; and outputting, based on the sold-out information, the request for the advertisement, and the second notification, standard advertisement information of the store to the second communication terminal, the standard advertisement information not including the limited product.

According to this configuration, in response to the request for the advertisement from a user in the vicinity of the store or a user in the store, if the limited product is sold out, a standard advertisement not including the limited product is displayed. Therefore, it is possible to prevent the privileged advertisement from being displayed even if the limited product is sold out.

The method may further include: acquiring, from a third communication terminal of a third user, a request for the advertisement corresponding to the store, the third communication terminal being not within the reception range of the beacon signal; and outputting, based on the limited product information and the request for the advertisement, standard advertisement information of the store to the third communication terminal, the standard advertisement information not including the limited product.

With this configuration, when information is provided through the communication terminal, it is possible to distinguish between a person who actually visits the store and a person who does not visit the store, provide special information to the person who actually visits the store, and not provide the special information to the person who does not visit the store. Thus, it is possible to motivate a user to visit a real store by intentionally providing a border in the Web, which is a borderless world.

In the method, a monitor connected to the store terminal may be disposed in the store, and the limited product information may be acquired from the store terminal in synchronization with a first instruction to display on the monitor the limited product information. The first instruction is output from the store terminal to the monitor.

According to this configuration, when the limited product information is notified through the monitor in the store, it is possible to cause the store management system to promptly acquire the limited product information, and it is possible to prevent occurrence of a time lag regarding acquisition of the limited product information in the store terminal and the store management system.

In the method, a monitor connected to the store terminal may be disposed in the store, and the sold-out information may be acquired from the store terminal in synchronization with a second instruction to erase a display of the limited product information from the monitor. The second instruction is output from the store terminal to the monitor.

According to this configuration, when the limited product information is deleted from the monitor in the store, it is possible to promptly notify this to the store management system, and it is possible to prevent occurrence of a time lag regarding deletion of the limited product information in the store terminal and the store management system.

In the method, the time available for sale may be shorter than 24 hours.

According to this configuration, it is possible to prevent a product whose freshness is degraded from being handled as a limited product.

A method according to still another aspect of the present disclosure is a method to be executed in a communication terminal that communicates with a store management system connected to a store terminal, the method including: acquiring, from the store terminal via a network in the store management system, limited product information indicating a limited product for which a time available for sale in a store corresponding to the store terminal is limited; outputting a request for an advertisement corresponding to a first store to the store management system via the network; acquiring, in response to the request for the advertisement, i) first advertisement information representing a standard advertisement of the first store and ii) second advertisement information representing a privileged advertisement of the first store, the privileged advertisement including the limited product in the standard advertisement, the second advertisement information being generated using the limited product information in the store management system; detecting a beacon signal transmitted from a first beacon signal transmitter disposed in the first store; and if the beacon signal is not detected, displaying the standard advertisement of the store represented by the first advertisement information on a display of the communication terminal, and, if the beacon signal transmitted from the first beacon signal transmitter is detected, displaying the privileged advertisement of the store represented by the second advertisement information on the display of the communication terminal.

According to this configuration, the limited product information indicating the limited product for which the time available for sale is limited is acquired via the network, and the advertisement including the limited product is displayed to a person who is within the reception range of the beacon signal from the store.

Thus, for example, it is possible to timely provide information about the limited product, which changes from moment to moment depending on stock or time, to a person in the store or in the vicinity of the store through the information terminal.

In addition, the standard advertisement is displayed to a person who is outside the reception range of the beacon signal from the store. Thus, when information is provided through the communication terminal, it is possible to distinguish between a person who actually visits the store and a person who does not visit the store, provide special information to the person who actually visits the store, and not provide the special information to the person who does not visit the store. Thus, it is possible to motivate a user to visit a real store by intentionally providing a border in the Web, which is a borderless world.

Furthermore, according to this configuration, the advertisement information is generated in response to the request for the advertisement corresponding to the store from the first user and is output to the first communication terminal. Therefore, the advertisement is prevented from being displayed on the first communication terminal against the will of the user, and the user can be prevented from being bothered.

In the method, the detected beacon signal may include a device ID specifying one beacon signal transmitter that has transmitted the detected beacon signal, one store in which the one beacon signal transmitter is installed may be specified based on the device ID, and if the specified one store matches the first store, it may be determined that the detected beacon signal is transmitted from the first beacon signal transmitter, and the privileged advertisement of the store represented by the second advertisement information may be displayed on the display of the communication terminal.

According to this configuration, it is possible to display the privileged advertisement of the first store to a person who is within the reception range of the beacon signal from the first store.

In the method, if the specified one store does not match the first store, it may be determined that the detected beacon signal is transmitted from a second beacon signal transmitter disposed in a second store other than the first store, and the standard advertisement of the first store represented by the first advertisement information may be displayed on the display of the communication terminal.

According to this configuration, it is possible to display the standard advertisement of the first store to a person who is outside the reception range of the beacon signal from the first store.

Every processing in the above control method may be implemented in a communication terminal, a program, and a recording medium.

According to these configurations, it is possible to provide a communication terminal that executes the above-described control method, a program that executes the above-described control method, and a recording medium that stores the program.

### First Embodiment

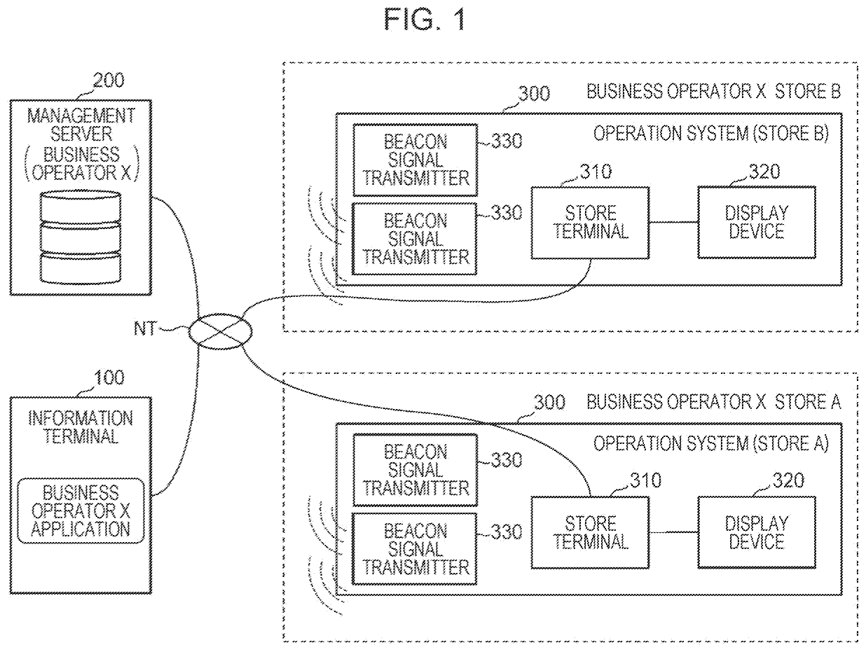

FIG. 1 is a block diagram illustrating an example of the overall configuration of an information providing system according to a first embodiment. The information providing system includes an information terminal 100, a management server 200 (an example of a store management system), and an operation system 300. The information terminal 100, the management server 200, and the operation system 300 are communicably connected to each other via a network NT. The network NT is configured by a wide area communication network including, for example, the Internet and a mobile phone communication network. The information terminal 100 is an example of a first communication terminal, a second communication terminal, and a third communication terminal.

The information terminal 100 is configured by a mobile information processing device such as a smartphone or a tablet terminal. The information terminal 100 is carried by a user to whom a service of a business operator X is provided. This service is a service for causing the information terminal 100 to display an advertisement of a product sold by a store of the business operator X. Application software of the business operator X (hereinafter referred to as a business operator X application) is installed in the information terminal 100. The business operator X application is application software for providing a service of the business operator X to a user.

The management server 200 is a cloud server composed of one or more computers. The management server 200 manages the types and stocks of products that the business operator X sells in stores, generates advertisement information, and causes the information terminal 100 to display the advertisement information.

A store A and a store B belong to the business operator X. The business operator X is a company that manages the store A and the store B. In this embodiment, the business operator X is a business operator who develops a chain of retail stores such as supermarkets. Therefore, the store A and the store B are stores belonging to the supermarket chain developed by the business operator X. In the example in FIG. 1, two stores, which are the store A and the store B, are illustrated, but this is an example, and the number of stores managed by the business operator X may be three or more, or one. The business managed by the business operator X is not limited to supermarkets, and may be a business for manufacturing and selling packed meals, a ready-made meal business for manufacturing and selling delicatessen, or a fast-food business. Products that the stores sell in this embodiment may include, for example, perishable foods such as vegetables, fruits, seafood, and meats, beverages such as coffees, fruit juices, and teas, hamburgers, Sushi, packed meals, and delicatessen, and the like.

One or more operation systems 300 are present corresponding to each store. In the example in FIG. 1, two operation systems 300 respectively corresponding to the store A and the store B are illustrated. Each of the operation systems 300 is installed in a corresponding store, and performs product management, employee management, and the like in the corresponding store.

The operation system 300 includes a store terminal 310, a display device 320 (an example of a monitor), and a beacon signal transmitter 330. The store terminal 310 is configured by, for example, a desktop computer or a mobile information processing device such as a smartphone or a tablet terminal, and performs product management and employee management in the corresponding store. The store terminal 310 is connected to the management server 200 via the network NT, and transmits, to the management server 200 at any time, information such as the stock quantity of products that the store sells. The store terminal 310 generates or receives information to be displayed on the display device 320 and outputs the information to the display device 320, and thereby, the information is displayed.

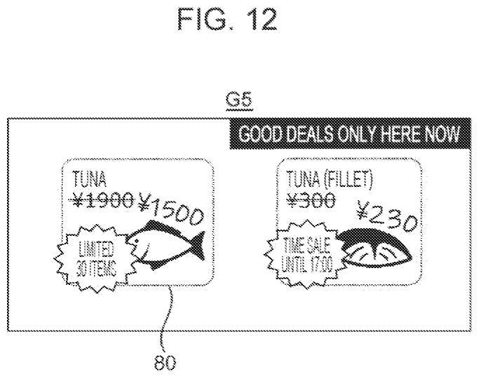

The display device 320 is constituted by, for example, a large-screen display device installed in a store front, and presents various kinds of information to users who visit the store. For example, under the control of the store terminal 310, the display device 320 displays a screen for displaying an advertisement related to the limited product illustrated in FIG. 12. Furthermore, when the limited product is sold out, the display device 320 may display information indicating that the limited product is sold out. In this embodiment, the time available for sale of the limited product is shorter than 24 hours. The time available for sale may be, for example, shorter than 12 hours, shorter than 6 hours, shorter than 3 hours, shorter than 1 hour, shorter than 30 minutes, shorter than 15 minutes, shorter than 10 minutes, or shorter than 5 minutes.

The beacon signal transmitter 330 is installed in a store and transmits a beacon signal. A plurality of beacon signal transmitters 330 are disposed in the store or around the store so that, for example, a main area or all areas in the store and/or an area within a certain range around the store can fall within a communication range. As the beacon signal, a signal conforming to Bluetooth (registered trademark) can be adopted. However, this is merely an example, and as the beacon signal, an infrared beacon signal may be adopted, a wireless communication method that covers a relatively wide area with low power consumption called low power wide area (LPWA) may be adopted, or a cellular network for mobile phones may be adopted.

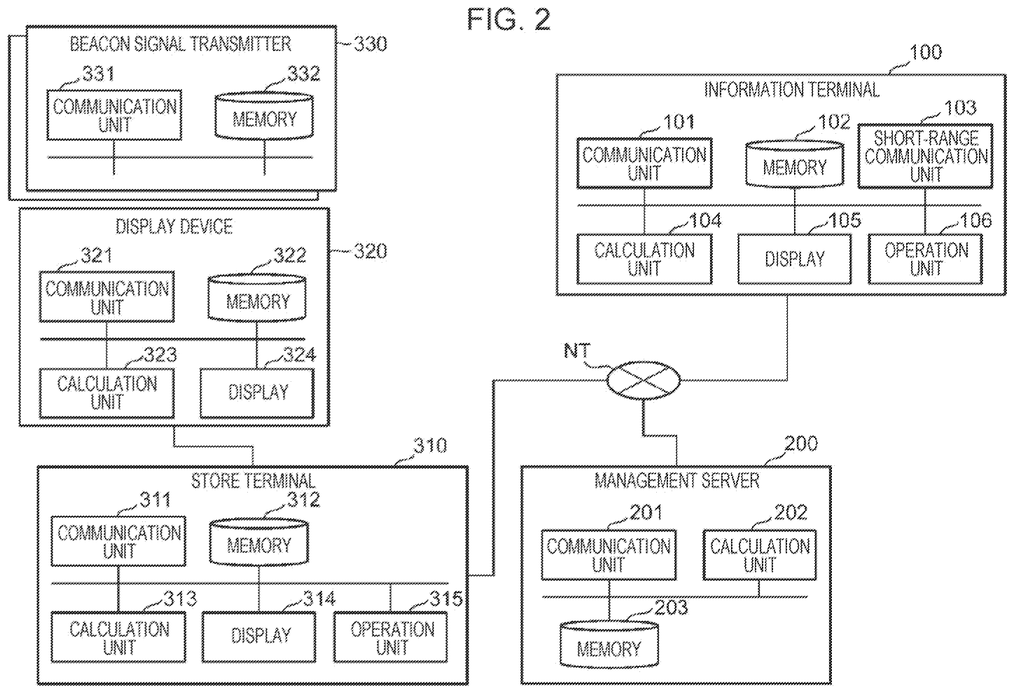

FIG. 2 is a block diagram illustrating an example of a detailed configuration of the information providing system according to the first embodiment. The information terminal 100 includes a communication unit 101, a memory 102, a short-range communication unit 103, a calculation unit 104, a display 105, and an operation unit 106.

The communication unit 101 is configured by, for example, a communication circuit for connecting the information terminal 100 to the network NT. The communication unit 101 transmits, to the management server 200, for example, a store identifier (ID) of a store for which the user desires to display an advertisement, “beacon reception: successful” indicating that a beacon signal has been successfully received in the store or “beacon reception: failed” indicating that the reception of a beacon signal has been failed in the store, and an advertisement request by which the user desires to acquire advertisement information.

The memory 102 is configured by a nonvolatile storage device such as a flash memory. The memory 102 stores, for example, a store dictionary for specifying a store in which the beacon signal transmitter 330 is installed from a device ID of the beacon signal transmitter 330 included in the beacon signal.

The short-range communication unit 103 is configured by a communication circuit for performing short-range communication such as Bluetooth (registered trademark). The short-range communication unit 103 receives a beacon signal transmitted from the beacon signal transmitter 330.

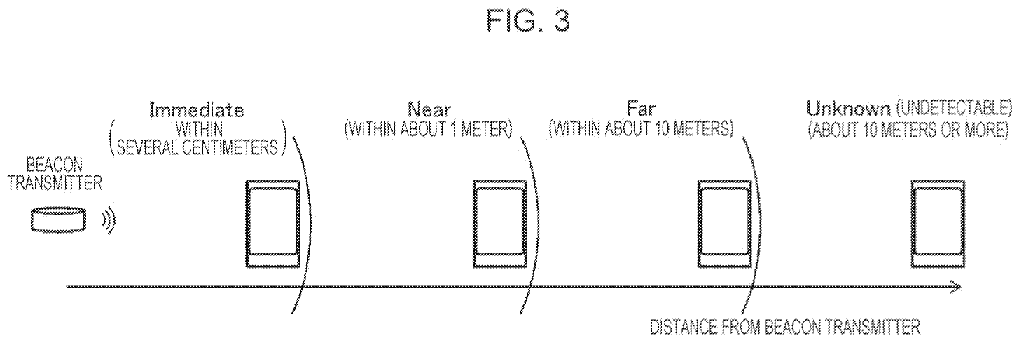

The calculation unit 104 is configured by a processor such as a central processing unit (CPU), and controls the entire information terminal 100. The calculation unit 104 may determine that the reception of a beacon signal has been failed if the detection result of the beacon signal by the short-range communication unit 103 is, for example, “Unknown” illustrated in FIG. 3, and may determine that the reception of a beacon signal has been successful if the detection result is other than “Unknown”. For example, the calculation unit 104 performs a process of specifying the store corresponding to the device ID included in the beacon signal received by the short-range communication unit 103 with reference to the store dictionary stored in the memory 102.

The display 105 is configured by a display device such as a liquid crystal panel or an organic electroluminescent (EL) panel. The display 105 displays an advertisement of a store. The operation unit 106 includes, for example, a touch panel, and receives instructions from users.

The management server 200 includes a communication unit 201, a calculation unit 202, and a memory 203. The communication unit 201 is configured by a communication circuit that connects the management server 200 to the network NT. The communication unit 201 receives, for example, the store ID, “beacon reception: failed” or “beacon reception: successful”, and the advertisement request transmitted from the information terminal 100. Furthermore, the communication unit 201 transmits advertisement information for causing the information terminal 100 to display the advertisement of the store. The advertisement information may include, for example, layout information for specifying a display position or the like of a graphical user interface (GUI) component constituting the advertisement and various image data of the GUI component. As described later, there are two types of advertisement information, which are privileged advertisement information and standard advertisement information. Furthermore, the communication unit 201 receives, from the store terminal 310, limited product information indicating a limited product for which the time available for sale in the store corresponding to the store terminal 310 is limited. Furthermore, the communication unit 201 receives sold-out information indicating that the limited product has been sold out in the store.

The calculation unit 202 is configured by a processor such as a CPU, and controls the entire management server 200. The calculation unit 202 receives, via the communication unit 201, the limited product information indicating the limited product for which the time available for sale in the store corresponding to the store terminal 310 is limited. In a case where the limited product information is acquired, upon reception of the store ID, “beacon reception: successful”, and the advertisement request from the information terminal 100 via the communication unit 201, the calculation unit 202 generates privileged advertisement information in which the limited product indicated by the limited product information is added to a standard advertisement of the store indicated by the store ID, and transmits the privileged advertisement information to the information terminal 100 via the communication unit 201.

In a case where the sold-out information indicating that the limited product has been sold out is received via the communication unit 201, upon reception of the store ID, “beacon reception: successful” or “beacon reception: failed”, and the advertisement request from the information terminal 100 via the communication unit 201, the calculation unit 202 transmits standard advertisement information which is advertisement information not including the limited product to the information terminal 100 via the communication unit 201.

In a case where the limited product information is received via the communication unit 201, upon reception of the store ID, “beacon reception: failed”, and the advertisement request from the information terminal 100 via the communication unit 201, the calculation unit 202 transmits the standard advertisement information to the information terminal 100 via the communication unit 201.

The memory 203 stores, for example, a product database that manages products that each store sells and the stock quantity of the products. The memory 203 stores, for example, a purchase history database that manages a purchase history of products that each store sells.

The store terminal 310 includes a communication unit 311, a memory 312, a calculation unit 313, a display 314, and an operation unit 315. The communication unit 311 is configured by a communication circuit that connects the store terminal 310 to the network NT. The communication unit 311 transmits the limited product information and the sold-out information to the management server 200. Note that the store terminal 310 and the display device 320 are connected to each other via, for example, a local area network. Therefore, the communication unit 311 may have a communication function of communicating with the display device 320 via the local area network.

The memory 312 stores, for example, a store product database, for each store, which manages the types of products that the store sells, the stock quantity of the products, and the like. The memory 312 further stores, for example, a work database that manages work statuses, work schedules, actual working hours, and the like of employees of the store.

The calculation unit 313 is configured by a processor such as a CPU. In a case where an input instruction (an example of a first instruction) for displaying the limited product information on the display device 320 from an employee of the store is acquired, or in a case where the generation of a product to be handled as a limited product depending on a remaining sales time of the product or the like is detected, the calculation unit 313 outputs a command and/or display data for displaying the limited product information to the display device 320. The calculation unit 313 transmits the limited product information to the management server 200 in synchronization with the output of the command and/or display data for displaying the limited product information. Thus, the management server 200 can acquire the limited product information in synchronization with the input instruction for displaying the limited product information or at the same time as the calculation unit 313 detecting the generation of the limited product.

In a case where an input instruction (an example of a second instruction) for deleting the limited product information, which is displayed, is acquired, or in a case where it is detected that the limited product is sold out, the calculation unit 313 outputs a command and/or display data for deleting the limited product information to the display device 320. In synchronization with the output of the command and/or display data for deleting the limited product information, the calculation unit 313 transmits, to the management server 200, the sold-out information indicating that the product indicated by the limited product information is sold out. Thus, the management server 200 can acquire the sold-out information in synchronization with the input instruction for deleting the limited product information or at the same time as the calculation unit 313 detecting that the limited product is sold out.

The display 314 is configured by a display device such as a liquid crystal panel or an organic EL panel. The operation unit 315 includes input devices such as a keyboard and a mouse. The operation unit 315 acquires an input instruction for displaying the limited product information and/or a condition for handling a product as a limited product and an input instruction for deleting the limited product information input by an employee. Note that the operation unit 315 may also include a touch panel.

The display device 320 includes a communication unit 321, a memory 322, a calculation unit 323, and a display 324. The communication unit 321 is configured by a communication circuit for connecting the display device 320 to a local area network. The communication unit 321 receives, from the store terminal 310, a command and/or display data for displaying the limited product information and a command and/or display data for deleting the limited product information.

The memory 322 stores image data and the like to be displayed on the display 324. The calculation unit 323 is configured by a processor such as a CPU. The calculation unit 323 causes the display 324 to display the limited product information upon acquisition of the command and/or display data for displaying the limited product information, and deletes the limited product information from the display 324 upon acquisition of the command and/or display data for deleting the limited product information. The display 324 is configured by a display device such as a liquid crystal panel or an organic EL panel, and displays the limited product information and the like under the control of the calculation unit 323.

The beacon signal transmitter 330 is, for example, a transmitter conforming to the Bluetooth Low Energy (BLE) standard, and includes a communication unit 331 and a memory 332. The communication unit 331 periodically transmits a beacon signal including the device ID stored in the memory 332. The beacon signal is used to detect and determine whether a certain user carrying the information terminal 100 in which the business operator X application is installed is present in a certain store or in the vicinity of the store. There is a case where the store is larger than the reach range of the beacon signal transmitted by one beacon signal transmitter. In this case, by installing a plurality of beacon signal transmitters 330 in the store, it is possible to detect and determine that the user is in the store or in the vicinity of the store without exception.

The memory 332 is configured by a rewritable nonvolatile storage device such as a flash memory, and stores a device ID for uniquely specifying the beacon signal transmitter 330.

FIG. 3 is an explanatory diagram relating to a beacon signal. A platform called iBeacon (registered trademark, the same applies hereinafter) is known as a standard of the beacon signal, and iBeacon is illustrated in the example in FIG. 3. In iBeacon, the distance between the beacon signal transmitter 330 and the information terminal 100 is measured based on the radio wave intensity when the information terminal 100 receives the beacon signal. In iBeacon, the measured distance may be roughly classified into four types: Immediate, Near, Far, and Unknown. For example, Immediate indicates that the distance between the beacon signal transmitter 330 and the information terminal 100 is within several centimeters; Near indicates that the distance is within about 1 m; Far indicates that the distance is within about 10 m; and Unknown indicates that the distance is greater than or equal to about 10 m.

The beacon signal includes a universally unique identifier (UUID). A service or the like can be identified by embedding unique data in the UUID. As a setting format of the value of the UUID, for example, a format conforming to ISO/IEC11578 can be adopted.

Since a UUID is used for identification of a service or the like in iBeacon, the information terminal 100 is incapable of responding to a beacon signal unless a smartphone application that knows a beacon ID or the like is installed in the information terminal 100. Therefore, it is necessary to install in advance a smartphone application corresponding to the UUID of a specific beacon signal in the information terminal 100 in iBeacon.

Another known platform for beacon signals is Eddystone (registered trademark). Eddystone includes a UID type and a URL type. In the UID type, since the beacon ID is transmitted as in iBeacon, it is necessary to install in advance an application corresponding to the beacon ID in the information terminal 100. In the URL type, a chrome browser can automatically designate a URL to access. Therefore, in a case of the URL type, the information terminal 100 only needs to have a chrome browser, and does not need to have an application corresponding to a specific beacon ID.

In this embodiment, based on reception of the beacon ID (device ID), a service such as notification of an advertisement of a store is provided to the user. Therefore, it is assumed that the business operator X application, which is a dedicated application having a function of responding to a beacon signal, is installed in the information terminal 100, and that the beacon ID (device ID), which is unique service identification information, is included in the beacon signal. In this embodiment, both iBeacon and Eddystone can be adopted. When the URL type of Eddystone is adopted, the information terminal 100 does not need to have the business operator X application, and only needs to have a chrome browser.

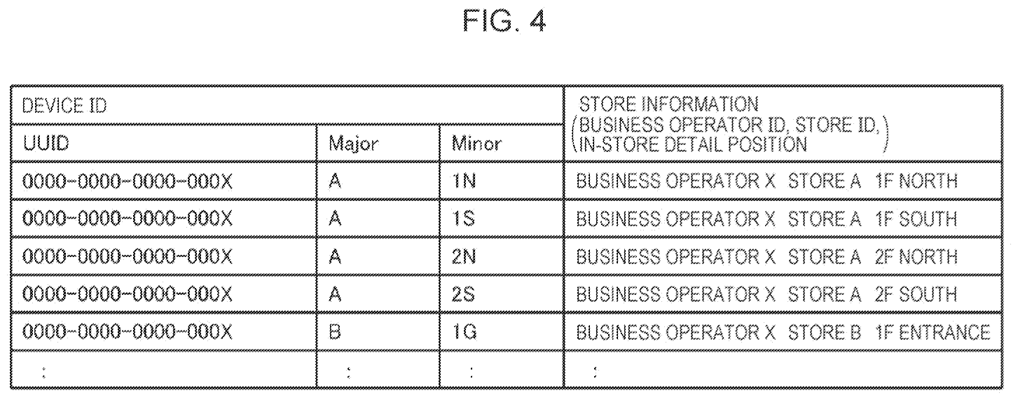

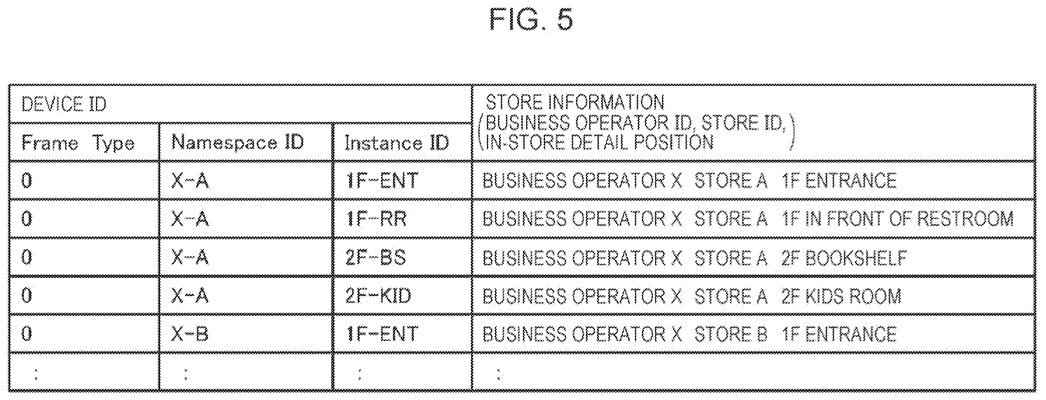

FIGS. 4 and 5 are diagrams illustrating examples of a data configuration of a store dictionary. FIG. 4 is a store directory for a case where iBeacon is adopted. FIG. 5 is a store directory for a case where the UID type of Eddystone is adopted. In a case of iBeacon, the store dictionary stores the device ID and store information in association with each other. The device ID includes a UUID, a Major value, and a Minor value. The UUID indicates an identifier of the business operator X. The Major value indicates an identifier of a store of the business operator X. The Minor value indicates a detailed position in the store indicated by the Major value. The store information includes a business operator ID, a store ID, and the detailed position in the store.

For example, in the first row, the business operator X, the store A, and the north of the 1F are associated with the UUID “0000-0000-0000-000X”, the Major value “A”, and the Minor value “1N”. Therefore, when the device ID in the first row is included in the received beacon signal, it is understood that the beacon signal is a signal transmitted from the beacon signal transmitter 330 installed in the north of the 1F of the store A of the business operator X. Therefore, it is understood that a user of the information terminal 100 that has received this beacon signal is located in the north of the 1F of the store A of the business operator X.

In a case of the UID type of Eddystone, the device ID includes a frame type, a namespace ID, and an instance ID, and the store information is the same as that in iBeacon. The frame type indicates the type of Eddystone. Here, “0” described in the frame type indicates the UID type. The namespace ID indicates a business operator and a store. The instance ID indicates a detailed position in the store. For example, in the first row, the business operator X, the store A, and the 1F entrance are associated with the frame type “0”, the namespace ID “X-A”, and the instance ID “1F-ENT”. Therefore, it is understood that a user of the information terminal 100 that has received this beacon signal is at the entrance of the 1F of the store A of the business operator X.

The associations between the beacon ID and the store information are examples, and any setting and operation may be performed as long as the association between the beacon ID and the store information can be realized.

Note that the position information of the user may be specified by combining the received beacon ID with a position information detection function provided in the information terminal 100 (for example, position determination by Global Positioning System, region determination by a connected mobile base station, and the like).

Next, a process performed by the information providing system according to the first embodiment will be described. In the first embodiment, each time an advertisement request is transmitted from the information terminal 100, the management server 200 generates privileged advertisement information.

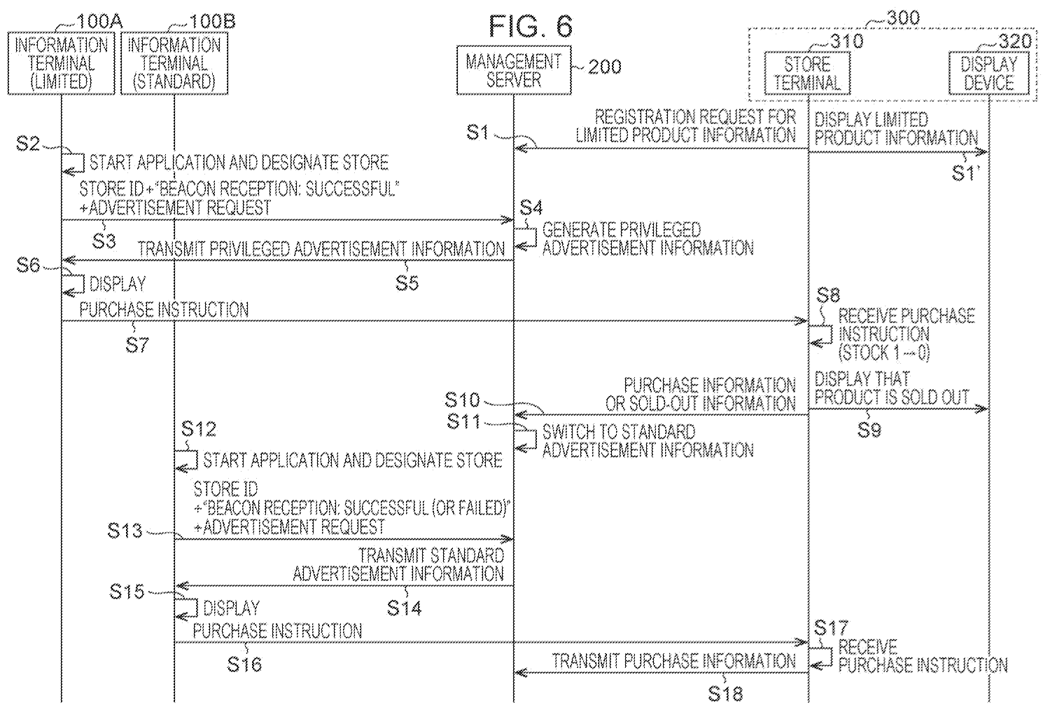

FIG. 6 is a sequence diagram illustrating an example of the process performed by the information providing system according to the first embodiment. In FIG. 6, an information terminal 100A indicates an information terminal 100 that receives privileged advertisement information (advertisement information including limited product information in addition to standard advertisement information). An information terminal 100B indicates an information terminal 100 that receives standard advertisement information. In FIG. 6, users of the information terminals 100A and 100B request an advertisement from the same store. This store may be a store where the users stop by while traveling, for example, on the way home, regardless of the current locations of the users.

First, upon reception of an instruction to display a limited product from an employee of a store or detection that a certain product satisfies a condition for being handled as a limited product, the store terminals 310 transmits a registration request for limited product information indicating the limited product to a management server 200 (step S1). As a result, the store terminal 310 registers the limited product information in the store product database, and sets the stock quantity of the limited product. Furthermore, having received the registration request for the limited product information, the management server 200 registers the limited product information in the product database of the corresponding store. Subsequently, the store terminal 310 causes the display device 320 to display the limited product information (steps S1′).

In step S2, the information terminal 100A starts the business operator X application in accordance with an instruction from the user, and receives an input instruction from the user to designate a store from which the user desires to display an advertisement.

Subsequently, the information terminal 100A determines whether a beacon signal corresponding to the designated store has been successfully received. Here, since the beacon signal has been successfully received, the information terminal 100A transmits the store ID of the designated store, “beacon reception: successful” indicating that the beacon signal has been successfully received, and an advertisement request to the management server 200 (step S3).

In step S3, the information terminal 100A may specify the store ID corresponding to the device ID included in the beacon signal using the store dictionary stored in the memory 102, and, if the specified store ID matches the store ID of the designated store, may determine that the beacon signal corresponding to the designated store has been successfully received.

The store ID and “beacon reception: successful” transmitted in step S3 are an example of a first notification indicating that the beacon signal including the device ID specifying the beacon signal transmitter 330 has been received from the beacon signal transmitter 330 disposed in the store. The advertisement request is an example of a request for an advertisement.

Subsequently, since the limited product information is registered in the store indicated by the received store ID through step S1, the management server 200 generates privileged advertisement information corresponding to the store (step S4). Here, the privileged advertisement information includes a product indicated by the limited product information in addition to products indicated by standard advertisement information of the corresponding store. Thus, it is possible to notify the limited product information only to users who have visited the store designated through the business operator X application, and it is possible to motivate the users to visit the store.

Subsequently, the management server 200 transmits the privileged advertisement information to the information terminal 100A (step S5). Subsequently, the information terminal 100A displays a privileged advertisement on the display 105 (step S6). Thus, the user can browse the privileged advertisement.

Subsequently, the information terminal 100A presents an instruction to purchase the limited product to the store terminal 310 (step S7). In this case, the user who has browsed the privileged advertisement may cause the information terminal 100 to display an initial screen G1, which will be described later, at a cash register of a store where the user purchases a product to present a purchase instruction.

Subsequently, the store terminal 310 receives the purchase instruction (step S8). Here, if the limited product is included in the product to be purchased, the stock quantity of the limited product is subtracted by the number thereof to be sold. Here, it is assumed that the number of limited products to be sold is one, and as a result, the stock quantity is changed from one to zero.

Having received the purchase instruction, the store terminal 310 reads authentication information included in the initial screen G1 described later to determine whether to sell the limited product at a special price, and if it is determined to sell the limited product at the special price, may settle the limited product at the special price. The special price is a price discounted from a standard price.

The authentication information includes information indicating whether the user is a user who is allowed to purchase the limited product at the special price. For example, only when the privileged advertisement information is received, the information terminal 100 may cause the authentication information to include information indicating that the user is allowed to purchase the limited product at the special price. Thus, the limited product can be sold at the special price only to the user who has browsed the privileged advertisement. As the authentication information, for example, a barcode or a quick response (QR) code (registered trademark, the same applies hereinafter) can be adopted. The store terminal 310 may read the authentication information with a barcode reader, a QR code reader, or the like. Alternatively, the store terminal 310 may read the authentication information by near-field communication (NFC) or the like which is short-range wireless communication.

Subsequently, the store terminal 310 causes the display device 320 to display information indicating that the limited product is sold out or refrains from displaying the limited product information (step S9). Furthermore, the store terminal 310 transmits sold-out information indicating that the limited product is sold out to the management server 200 (step S10). Having received the sold-out information, the management server 200 deletes the limited product information registered in the product database of the corresponding store. In a case where the limited product is not sold out, the store terminal 310 may transmit purchase information including the stock quantity of the limited product to the management server 200 instead of the sold-out information. Having received the purchase information, the management server 200 may subtract the stock quantity of the limited product registered in the product database of the corresponding store by the number thereof to be sold.

Having received the sold-out information, the management server 200 switches the setting of the advertisement of the corresponding store from the privileged advertisement information to the standard advertisement information (step S11).

In step S12, the information terminal 100B starts the business operator X application in accordance with an instruction from the user, and receives an input instruction from the user to designate a store from which the user desires to display an advertisement. Subsequently, the information terminal 100B determines whether the beacon signal corresponding to the designated store has been successfully detected, and, if the beacon signal has been successfully detected, transmits the store ID of the designated store, “beacon reception: successful” indicating that the beacon signal has been successfully received, and an advertisement request to the management server 200 (step S13). If the detection of the beacon signal has been failed, in step S13, the information terminal 100B transmits the store ID, “beacon reception: failed” indicating that the reception of the beacon signal has been failed, and an advertisement request to the management server 200. Here, the information terminal 100B may refer to the store dictionary stored in the memory 102 to determine whether the beacon signal corresponding to the designated store has been successfully detected.

Although “beacon reception: failed” is transmitted in step S13, “beacon reception: failed” is not necessarily transmitted. In this case, if “beacon reception: successful” is not transmitted in association with the store ID and the advertisement request, the management server 200 may determine that the beacon signal is not detected.

Subsequently, since the setting of the advertisement information is switched to the standard advertisement information in step S11, the management server 200 transmits the standard advertisement information to the information terminal 100B (step S14). The standard advertisement information is prepared for each store and is generated in advance. Therefore, in step S14, without generating the standard advertisement information, the management server 200 may read the standard advertisement information of the corresponding store generated in advance from the memory 203 and transmit it to the information terminal 100B.

Subsequently, the information terminal 100B displays the standard advertisement on the display 105 (step S15). Thus, the user can browse the standard advertisement.

Subsequently, the information terminal 100B presents an instruction to purchase a product from the user who has browsed the standard advertisement to the store terminal 310 (step S16), and the store terminal 310 receives the instruction to purchase the product (step S17). Subsequently, the store terminal 310 transmits purchase information indicating the stock quantity of the product to the management server 200 (step S18). Having received the purchase information, the management server 200 may update the stock quantity of the product registered in the product database of the corresponding store in accordance with the purchase information.

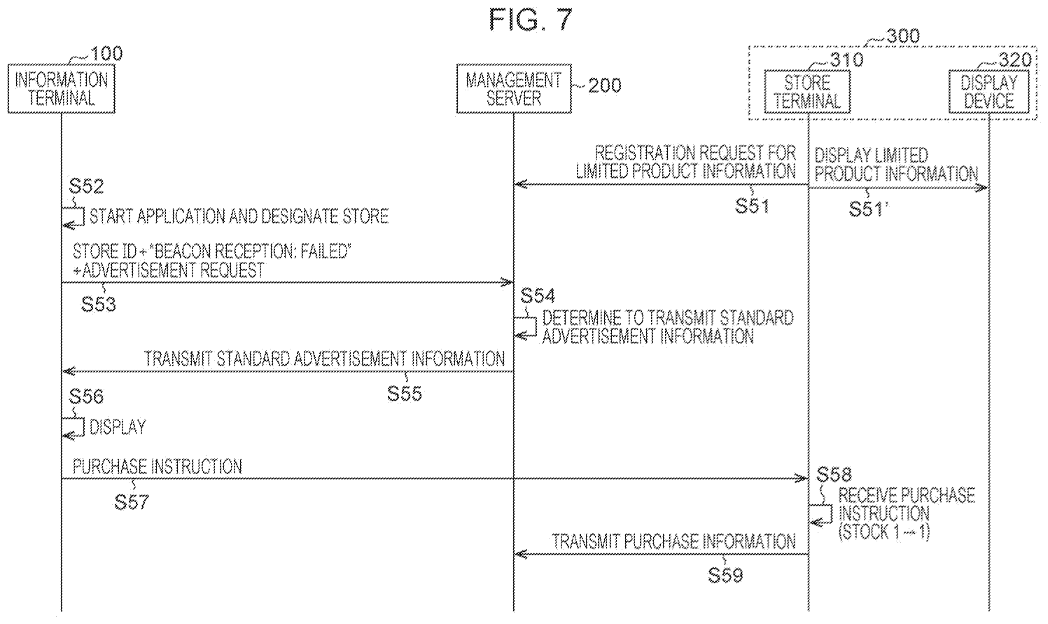

FIG. 7 is a sequence diagram illustrating an example of the process performed by the information providing system according to the first embodiment. FIG. 7 illustrates a process for a case where the information terminal 100 that has failed to detect a beacon signal transmits an advertisement request and the like.

Steps S51 and S51′ are the same as steps S1 and S1′ in FIG. 6, and the limited product information is registered in the management server 200.

In step S52, the information terminal 100 starts the business operator X application in accordance with an instruction from the user, and receives an input instruction from the user to designate a store from which the user desires to display an advertisement.

Subsequently, the information terminal 100 determines whether a beacon signal corresponding to the designated store has been successfully detected. Here, since the information terminal 100 is outside the communication range of the beacon signal corresponding to the designated store and the detection of the beacon signal has been failed, the information terminal 100 transmits the store ID of the designated store, “beacon reception: failed” indicating that the reception of the beacon signal has been failed, and an advertisement request to the management server 200 (step S53).

Although “beacon reception: failed” is transmitted here, “beacon reception: failed” is not necessarily transmitted. In this case, if “beacon reception: successful” is not transmitted in association with the store ID and the advertisement request, the management server 200 may determine that the beacon signal is not detected.

Subsequently, since “beacon reception: failed” is received, the management server 200 determines to transmit the standard advertisement information (step S54). Subsequently, the management server 200 transmits the standard advertisement information to the information terminal 100 (step S55).

Steps S56 and S57 are the same as steps S6 and S7 in FIG. 6. Subsequently, the store terminal 310 receives the instruction to purchase the product (step S58). Here, since the limited product is not ordered, the stock quantity of the limited product is maintained as it is. In this example, the stock quantity is maintained as 1. Subsequently, the store terminal 310 transmits purchase information to the management server 200 (step S59). Having received the purchase information, the management server 200 updates the product database of the corresponding store to the stock quantity of the product included in the purchase instruction.

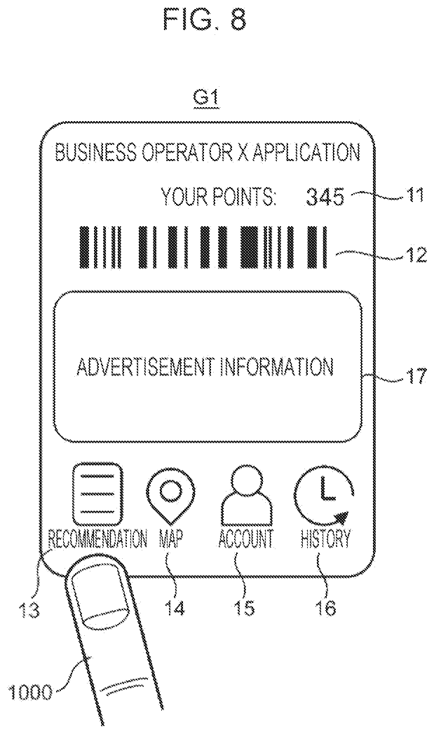

FIG. 8 is a diagram illustrating an example of the initial screen G1 of the business operator X application. The initial screen G1 is displayed on the display 105 when a user inputs an instruction to start the business operator X application to the information terminal 100. The initial screen G1 includes a point display field 11, an authentication information display field 12, and an advertisement display field 17.

The point display field 11 displays points of the business operator X application accumulated by the user. The authentication information display field 12 displays authentication information including information indicating whether the user is allowed to purchase a limited product at a special price. Here, a bar code is adopted as the authentication information. However, this is an example, and a QR code may also be adopted.

For example, the user presents the barcode to an employee of a store at the time of checkout of a product. The employee has the barcode reader read the authentication information. Thus, the store terminal 310 acquires the authentication information. The store terminal 310 analyzes the acquired authentication information and determines whether the corresponding user is allowed to purchase a limited product at a special price. If it is determined that the user is allowed to purchase a limited product at a special price, the store terminal 310 performs settlement of the limited product at the special price. On the other hand, if it is determined that the user is not allowed to purchase a limited product at a special price, the store terminal 310 performs settlement of the limited product at the normal price. In a case where products to be purchased by the user include products other than the limited product, the store terminal 310 may perform settlement for the limited product at the special price, and may perform settlement for the rest of the products at the normal price.

Here, an example in which the authentication information is read by a scanner such as a barcode reader has been described. However, this is only an example. For example, the store terminal 310 may read the authentication information by short-range wireless communication such as NFC. In this case, the user may have the store terminal 310 read the authentication information by bringing the information terminal 100 close to a communication device of short-range wireless communication connected to the store terminal 310.

In the advertisement display field 17, an advertisement of a recommended product, service, or the like of the business operator X is displayed. The number of advertisement display fields may be one, or two or more.

In a lower part of the initial screen G1, a recommendation button 13, a map button 14, an account button 15, and a history button 16 are provided. The recommendation button 13 is a button to be selected when displaying information related to a good deal recommended by the business operator X. Hereinafter, the selection operation is referred to as “touch”. The map button 14 is a button to be touched in order to check stores of the business operator X on a map around the current location. The account button 15 is a button to be touched when registering, checking, or updating a user account. The history button 16 is a button to be touched when referring to the user's past order history.

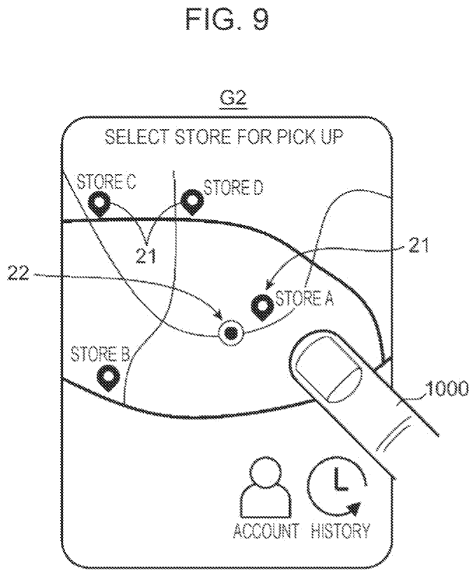

FIG. 9 is a diagram illustrating an example of a map screen G2. The map screen G2 is displayed when the map button 14 is touched on the initial screen G1. A map around the current location of the user is displayed on the map screen G2. On the map screen G2, a current location icon 22 indicating the current location of the user is displayed. On the map screen G2, store icons 21 indicating stores around the current location are displayed. Here, four store icons 21 of stores A, B, C, and D are displayed, and the user can check that there are four stores belonging to the business operator X around the current location. The user browses the map screen G2 and selects a store where they desire to visit. In this example, the user touches the store icon 21 of the store A with an indicator 1000 to select the store A. The indicator 1000 is, for example, a finger of the user. Upon the store icon 21 of the store A being touched, the information terminal 100 determines whether a beacon signal corresponding to the store A has been successfully received, and transmits the store ID of the store A, “beacon reception: successful” or “beacon reception: failed”, and an advertisement request to the management server 200. This processing corresponds to steps S3 and S13 in FIG. 6. Here, since the information terminal 100 is outside the communication range of the beacon signal corresponding to the store A and the reception of the beacon signal has been failed, “beacon reception: failed” is transmitted. Therefore, the standard advertisement information is transmitted from the management server 200 to the information terminal 100.

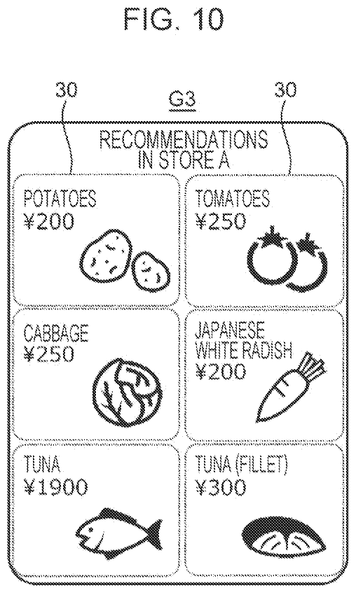

FIG. 10 is a screen diagram illustrating an example of a standard advertisement G3. On the standard advertisement G3, one or more products recommended to be purchased by the store A selected by the user are displayed. Here, since the store A is a supermarket, perishable foods are displayed on the standard advertisement G3. However, this is merely an example, and the standard advertisement G3 may include daily necessities, electric products, and the like. “Recommendations in Store A” is displayed in an upper part of the standard advertisement G3 to indicate that the standard advertisement G3 is an advertisement of the store A. On the standard advertisement G3, tile objects 30 corresponding to respective products recommended by the store A are displayed. Each of the tile objects 30 has a rectangular outer frame, and displays a product name, a price of the product, and an image indicating the product. Here, tile objects 30 corresponding to perishable foods such as potatoes and tomatoes are displayed.

Although the tile objects 30 here are arranged in three rows x two columns, this is an example. In addition, the tile objects 30 have the same size. When a scroll operation is input on the standard advertisement G3, the information terminal 100 scrolls the standard advertisement G3 and displays tile objects 30 that have not been displayed on the display 105. Thus, the user can cause the display 105 to display tile objects 30 of products hidden on the initial screen of the standard advertisement G3.

The standard advertisement information includes layout information for specifying display positions of the tile objects 30 on the standard advertisement G3, a priority order of the products, image data of the tile objects 30, and the like. Therefore, the information terminal 100 may draw the standard advertisement G3 by arranging the tile objects 30 corresponding to the products in descending order of priorities in accordance with the layout information. The priority order of the products is defined in advance in the store A. For example, the order may be such that a more popular product has a higher priority. Here, the standard advertisement G3 may be different for each store or may be an advertisement common to all stores of the business operator X.

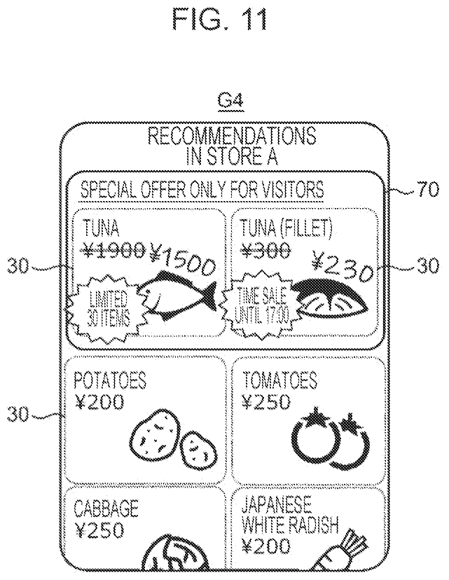

FIG. 11 is a screen diagram illustrating an example of a privileged advertisement G4. The privileged advertisement G4 is displayed when the user is near the store A designated by the user on the map screen G2, at a timing when the user can purchase the limited product in the store A. That is, at a timing immediately before the user displays the advertisement of the store A, the information terminal 100 of the user detects a beacon signal corresponding to the store A. Then, the information terminal 100 transmits the store ID of the store A, “beacon reception: successful”, and the advertisement request in association with each other to the management server 200. Thus, the information terminal 100 receives the privileged advertisement information, and displays the privileged advertisement G4 on the display 105. This processing corresponds to steps S3 to S6 in FIG. 6.

Unlike in the standard advertisement G3 illustrated in FIG. 10, a limited product field 70 indicating the current limited products of the store A is arranged in an upper part of the privileged advertisement G4. Thus, it is possible to appeal the presence of the limited products to the user in an easy-to-understand manner.

The width of the limited product field 70 is approximately twice the width of the tile object 30. Tile objects 30 indicating limited products are arranged in the limited product field 70. Here, two tile objects 30 indicating a tuna and a tuna fillet are arranged in the limited product field 70. In each of the tile objects 30, in addition to the product name of the limited product and the image indicating the limited product, the prices of the limited product before and after the discount are displayed. For example, in the tile object 30 of the tuna, a double line is drawn on 1900 yen, which is the normal price before the discount, and 1500 yen, which is the special price after the discount, is displayed adjacent to the normal price. Similarly, in the tile object 30 of the tuna fillet, a double line is drawn on 300 yen, which is the price before the discount, and 230 yen, which is the price after the discount, is displayed. Thus, the user can grasp the discount amounts of the limited products.

Furthermore, since the tuna is a limited product with a limited quantity, a message “only 30 tunas” indicating that the quantity is limited is displayed in the tile object 30 of the tuna. Thus, the user can recognize that the quantity of the tuna is limited.

Furthermore, since the tuna fillet is a limited product with a limited purchase time, a message “time sale until 17:00” indicating that the purchase time is limited is displayed in the tile object 30 of the tuna fillet. Thus, the user can recognize that the purchase time of the tuna fillet is limited. A message indicating that the quantity is limited may be displayed in the tile object 30 of the limited product with a limited quantity, and a message indicating that the purchase time is limited may be displayed in the tile object 30 of the limited product with a limited purchase time.

Furthermore, a message stating “special offer only for visitors” is displayed in the limited product field 70. This message can cause the user to recognize the products displayed in the limited product field 70 are limited products presented only to users who visit the store A.

On the privileged advertisement G4, the standard advertisement is displayed below the limited product field 70. In the standard advertisement, as in the standard advertisement G3 illustrated in FIG. 10, the tile objects 30 are arranged according to the priority order of the products.

As in the standard advertisement G3, the privileged advertisement G4 is configured to be scrollable. Therefore, by performing a scroll operation, the user can cause tile objects 30 that have not been displayed on the initial screen of the privileged advertisement G4 to be displayed, and can browse an advertisement of low-priority products.

When there are three or more limited products, the three or more limited products are displayed in the limited product field 70 on the privileged advertisement G4. In this case, the information terminal 100 may display the tile objects 30 of the three or more limited products in the single limited product field 70, for example, in M rows x N columns on the privileged advertisement G400. Here, each of M and N is an integer of 1 or more. When there is a single limited product, the information terminal 100 may display the single limited product in the limited product field 70 on the privileged advertisement G4.

The privileged advertisement information transmitted from the management server 200 includes layout information indicating display positions of the limited product field 70, the tile objects 30, and the like, information for specifying the limited product, the priority order of the products, image data of the tile objects 30 corresponding to the products, and the like. Therefore, the information terminal 100 may draw the privileged advertisement G4 on the display 105 by arranging the limited product field 70 and the tile objects 30 in accordance with the layout information.

FIG. 12 is a diagram illustrating an example of an advertisement screen G5 displayed on the display device 320. The advertisement screen G5 is a screen for displaying an advertisement of the store A to users of the business operator X application who visit the store A. In this example, an advertisement of limited products is displayed on the advertisement screen G5. Currently, since the tuna and the tuna fillet are the limited products, tile objects 80 respectively corresponding to the tuna and the tuna fillet are displayed on the advertisement screen G5. The display content of the tile objects 80 is the same as that of the tile objects 30. Thus, users who visit the store A can check the limited products. A user who desires to purchase a limited product, for example, starts the business operator X application, selects the store A from the map screen G2, causes the display 105 to display the privileged advertisement G4. Then, the user presents the initial screen G1 at the time of settlement of the limited product. Thus, the user can purchase the limited product at the special price.

Note that the user may be able to purchase a limited product without necessarily performing the above-described operation. For example, a QR code may be displayed in advance on the advertisement screen G5 and it is read by the information terminal 100, and thus, the authentication information for purchasing a limited product may be displayed on the display 105 of the information terminal 100 even if the business operator X application is not installed. Alternatively, for a user who has installed the business operator X application and has acquired the device ID of the beacon signal transmitter 330 installed in the store A, limited product information to be displayed on the display device 320 of the store A, or limited product information prepared for this user (which may be different from the limited product information to be displayed on the display device 320), may be displayed in the advertisement display field 17 on the initial screen G1 of the business operator X application at a timing when the business operator X application is started, and a limited product may be purchased at a special price.

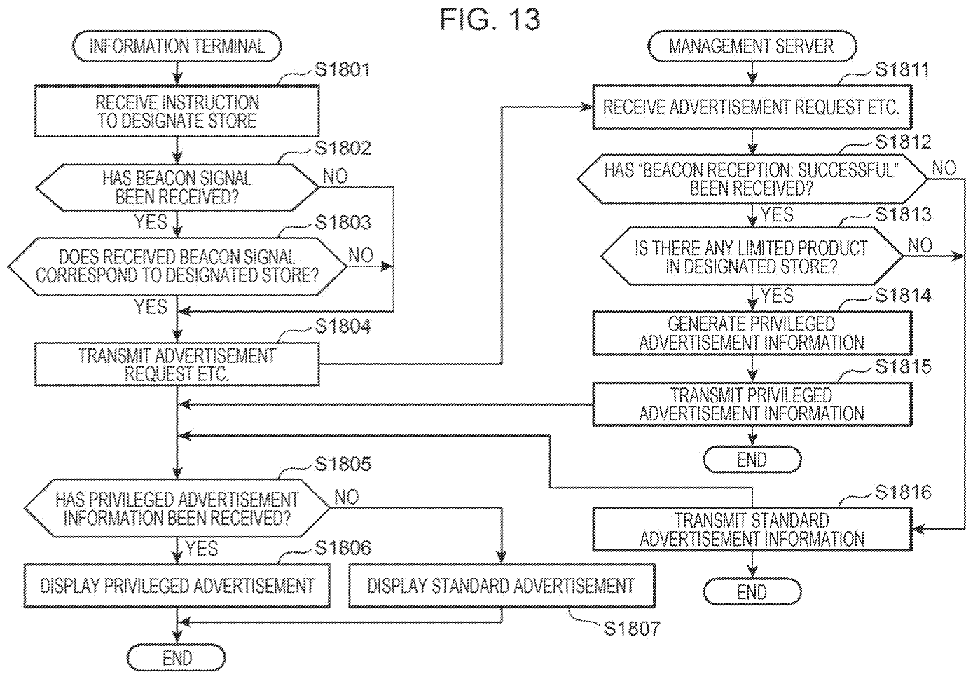

Next, the process performed by the information providing system according to the first embodiment will be described in detail. FIG. 13 is a flowchart illustrating details of the process performed by the information providing system according to the first embodiment.

First, the operation unit 106 of the information terminal 100 receives an instruction from a user to designate a store (step S1801). This processing corresponds to step S2 in FIG. 6. Here, it is assumed that the store A is selected by the user.

Subsequently, the calculation unit 104 of the information terminal 100 determines whether the short-range communication unit 103 has successfully received a beacon signal (step S1802). If the reception of the beacon signal has been failed (NO in step S1802), the process proceeds to step S1804. If the beacon signal has been successfully received (YES in step S1802), the process proceeds to step S1803.

In step S1803, the calculation unit 104 of the information terminal 100 determines whether the received beacon signal is a beacon signal corresponding to the store A designated in step S1801. In this case, the calculation unit 104 specifies the store ID corresponding to the device ID included in the received beacon signal by referring to the store dictionary, and determines whether the specified store ID matches the store ID of the store A. If they match, the calculation unit 104 determines YES in step S1803. If they do not match, the calculation unit 104 determines NO in step S1803.

Subsequently, the calculation unit 104 of the information terminal 100 transmits an advertisement request and the like to the management server 200 via the communication unit 101 (step S1804). Here, if YES is determined in step S1803, the calculation unit 104 transmits the store ID of the store A designated in step S1801, “beacon reception: successful”, and the advertisement request to the management server 200 via the communication unit 101. This processing corresponds to step S3 in FIG. 6. On the other hand, if NO is determined in step S1802 or S1803, the calculation unit 104 transmits the store ID of the store A designated in step S1801, “beacon reception: failed”, and the advertisement request to the management server 200 via the communication unit 101. This process corresponds to step S13 in FIG. 6 and step S53 in FIG. 7.

In step S1811, the communication unit 201 of the management server 200 receives the advertisement request and the like.

Subsequently, the calculation unit 202 of the management server 200 determines whether “beacon reception: successful” is included in the advertisement request and the like received in step S1811 (step S1812). If “beacon reception: successful” is included (YES in step S1812), the process proceeds to step S1813. If “beacon reception: failed” is included (NO in step S1812), the process proceeds to step S1816.

In step S1813, the calculation unit 202 determines whether there is any limited product in the store (store A) designated in step S1801. Here, if limited product information is registered in the product database of the store A stored in the memory 203, the calculation unit 202 may determine that there is a limited product in the store A. If limited product information is not registered in the product database of the store A, the calculation unit 202 may determine that there is no limited product in the store A.

If it is determined in step S1813 that there is a limited product in the store A (YES in step S1813), the process proceeds to step S1814. If it is determined in step S1813 that there is no limited product in the store A (NO in step S1813), the process proceeds to step S1816.

In step S1814, the calculation unit 202 generates privileged advertisement information in which the limited product indicated by the limited product information is added to standard advertisement information of the store A.

Subsequently, the calculation unit 202 transmits the privileged advertisement information of the store A to the information terminal 100 via the communication unit 201 (step S1815). In step S1816, the calculation unit 202 transmits the standard advertisement information to the information terminal 100 via the communication unit 201.

In step S1805, the calculation unit 104 of the information terminal 100 determines whether the privileged advertisement information has been received. If the privileged advertisement information has been received (YES in step S1805), the calculation unit 104 displays the privileged advertisement on the display 105 (step S1806). On the other hand, if the standard advertisement information has been received (NO in step S1805), the calculation unit 104 displays the standard advertisement on the display 105 (step S1807).

If the management server 200 also determines and transmits the display design of the advertisement information to the information terminal 100, the information terminal 100 may display the advertisement on the display 105 in accordance with the display design of the advertisement information received from the management server 200. This can be easily realized by using Hypertext Markup Language (HTML), for example. In this case, the determination in step S1805 is unnecessary, and the information terminal 100 may display advertisement information according to an instruction from the management server 200.

As described above, according to this embodiment, the limited product information indicating the limited product for which the time available for sale is limited is acquired, and the privileged advertisement including the limited product is displayed to a person who is within the reception range of the beacon signal from the store. Thus, it is possible to timely provide information about the limited product, which changes from moment to moment depending on stock or time, to a person in the store or in the vicinity of the store through the information terminal 100. As a result, food waste can be reduced.

Furthermore, according to this embodiment, the advertisement information is generated in response to the advertisement request corresponding to the store from the user and is output to the information terminal 100. Therefore, the advertisement is prevented from being displayed on the information terminal 100 against the will of the user, and the user can be prevented from being bothered.

### Second Embodiment

Next, a second embodiment will be described. In the second embodiment, the management server 200 generates privileged advertisement information in advance, and transmits the privileged advertisement information generated in advance to the information terminal 100 in response to reception of an advertisement request and the like. In this embodiment, the same components as those in the first embodiment are denoted by the same reference numerals, and description thereof will be omitted. Also, block diagrams and screen diagrams in this embodiment are the same as those in the first embodiment.

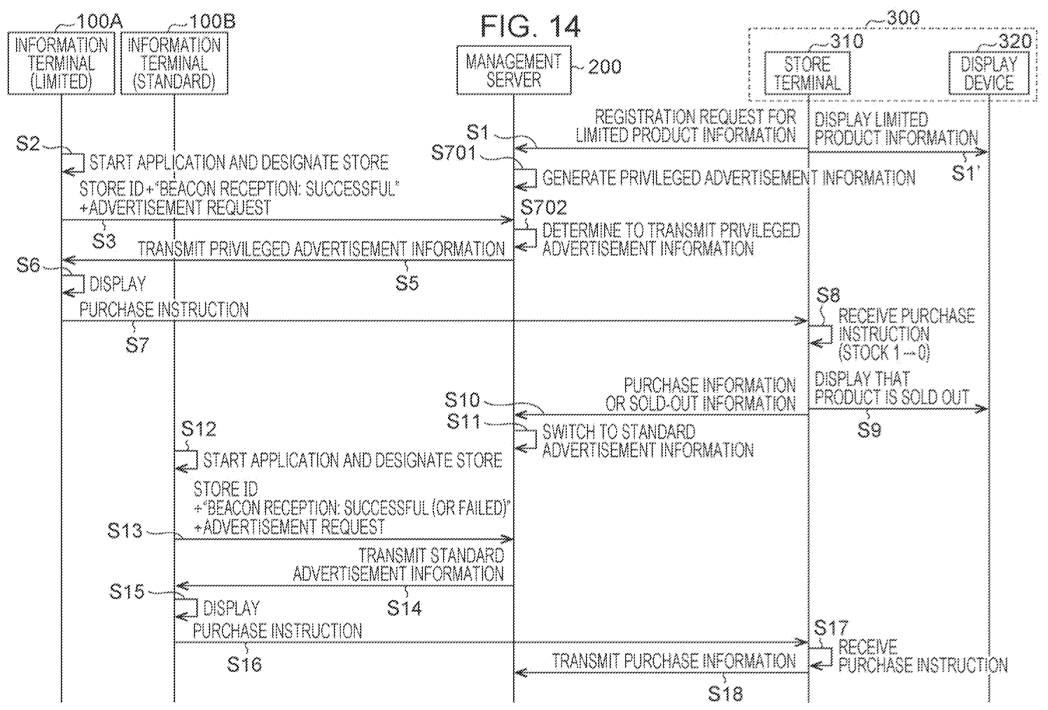

FIG. 14 is a sequence diagram illustrating an example of a process performed by an information providing system according to the second embodiment. In FIG. 14, the same processing as that in FIG. 6 is denoted by the same step number, and description thereof will be omitted.

In step S701, having received the registration request for the limited product information, the management server 200 generates privileged advertisement information based on the limited product information. This generation is different from that in FIG. 6 in that being triggered by the registration request for the limited product information, not the reception of the advertisement request and the like.

Subsequently, having received the store ID, “beacon reception: successful”, and the advertisement request, the management server 200 determines to transmit the privileged advertisement information (step S702). That is, upon reception of the advertisement request and the like, the management server 200 transmits the privileged advertisement information that is generated in advance to the information terminal 100A. In FIG. 14, the processing other than steps S701 and S702 is the same as that in FIG. 6.

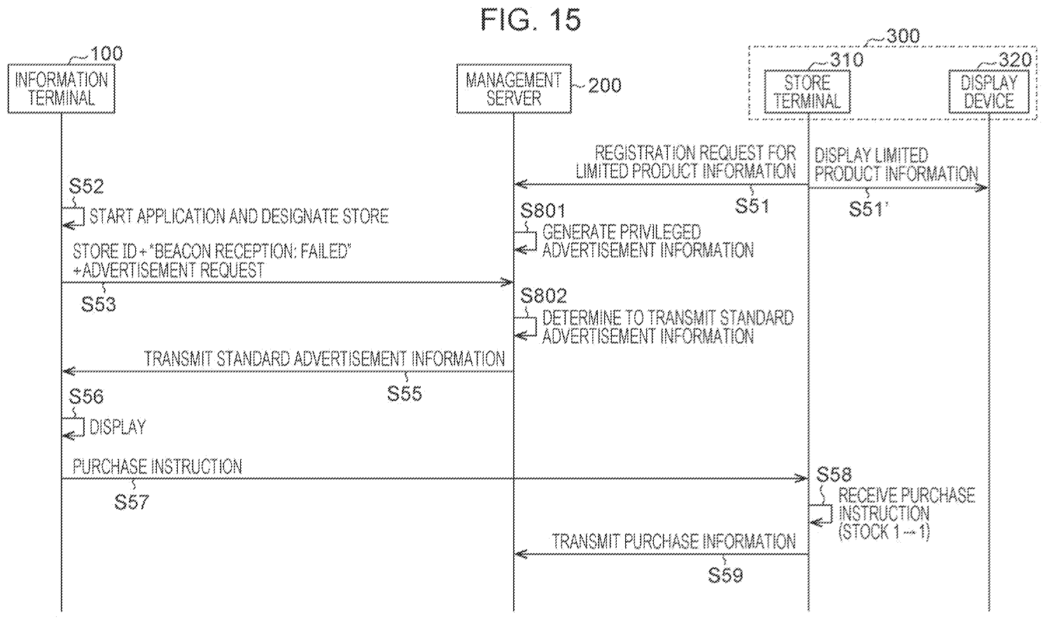

FIG. 15 is a sequence diagram illustrating an example of the process performed by the information providing system according to the second embodiment. FIG. 15 illustrates a process for a case where the information terminal 100 that has failed to detect a beacon signal transmits the advertisement request and the like in the second embodiment. In FIG. 15, the same processing as that in FIG. 7 is denoted by the same step number, and description thereof will be omitted.

In step S801, having received the registration request for the limited product information, the management server 200 generates privileged advertisement information based on the limited product information. This generation is different from that in the first embodiment in being triggered by the registration request for the limited product information, not the reception of the advertisement request and the like.

Subsequently, having received the store ID, “beacon reception: failed”, and the advertisement request, the management server 200 determines to transmit standard advertisement information (step S802). That is, since the management server 200 has received “beacon reception: failed”, the management server 200 transmits the standard advertisement information to the information terminal 100 instead of the privileged advertisement information that is generated in advance. In FIG. 15, the processing other than steps S801 and S802 is the same as that in FIG. 7.

As described above, according to the second embodiment, since it is not necessary to generate the privileged advertisement information each time the advertisement request and the like are received, it is possible to reduce the processing load of the management server 200.

### Third Embodiment

Next, a third embodiment will be described. In the third embodiment, both privileged advertisement information and standard advertisement information are transmitted from the management server 200 to the information terminal 100, and the information terminal 100 determines which of a privileged advertisement and a standard advertisement is to be displayed. In this embodiment, the same components as those in the first embodiment are denoted by the same reference numerals, and description thereof will be omitted. Also, block diagrams and screen diagrams in this embodiment are the same as those in the first embodiment.

FIG. 2 is to be referred to. In this embodiment, the management server 200 receives, via the communication unit 201, limited product information of the store A (first store) corresponding to the store terminal 310, from the store terminal 310 via the network NT.

The information terminal 100 transmits an advertisement (request for advertisement) corresponding to the store A to the management server 200 via the network NT. The information terminal 100 receives standard advertisement information (first advertisement information) of the store A and privileged advertisement information (second advertisement information) of the store A from the management server 200 in response to the advertisement request.

The information terminal 100 determines whether a beacon signal transmitted from the beacon signal transmitter 330 disposed in the store A has been detected using the short-range communication unit 103.

If the information terminal 100 has failed to detect the beacon signal, the information terminal 100 displays the standard advertisement of the store A on the display 105. On the other hand, if the information terminal 100 has successfully detected the beacon signal transmitted from the beacon signal transmitter 330 of the store A, the information terminal 100 displays the privileged advertisement of the store A on the display 105.

The information terminal 100 refers to the store dictionary stored in the memory 102 and specifies the store corresponding to the device ID included in the beacon signal. When the specified store matches the store A, the information terminal 100 determines that the beacon signal is a beacon signal corresponding to the store A. In this case, the information terminal 100 displays the privileged advertisement of the store A on the display 105.

If the specified store does not match the store A, the information terminal 100 determines that the detected beacon signal is a beacon signal corresponding to a store other than the store A, and displays the standard advertisement of the store A on the display 105.

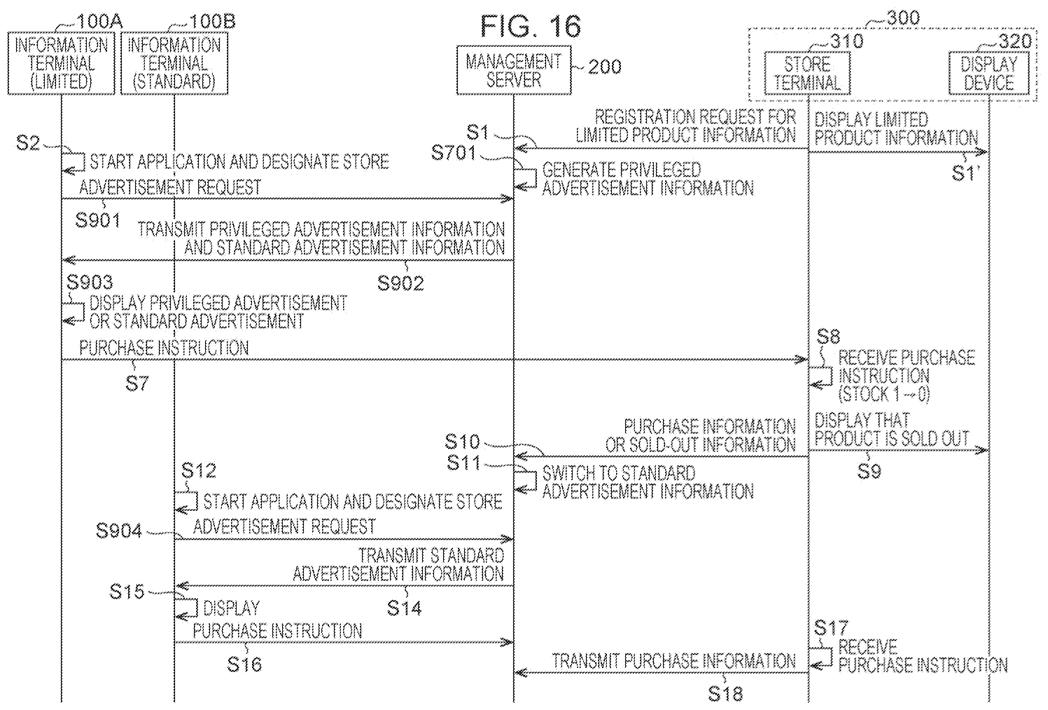

FIG. 16 is a sequence diagram illustrating an example of a process performed by an information providing system according to the third embodiment. FIG. 16 is based on FIG. 14, and the same processing as that in FIG. 14 is denoted by the same reference numeral, and description thereof will be omitted. Therefore, in this embodiment, it is assumed that the management server 200 generates the privileged advertisement information in advance, triggered by the reception of the limited product information. It is also assumed that the store designated in step S2 is the store A. However, this is an example, and the management server 200 may generate the privileged advertisement information triggered by the reception of the advertisement and the like as in the first embodiment.

In step S901, since the store A is designated by the user, the information terminal 100A transmits the advertisement request to the management server 200. This is different from step S3 in FIG. 14 in that the store ID and “beacon reception: successful” or “beacon reception: failed” are not transmitted, and only the advertisement request is transmitted. The advertisement request transmitted here may include the store ID of the store A.

Subsequently, the management server 200 transmits the privileged advertisement information of the store A and the standard advertisement information of the store A to the information terminal 100A (step S902). Here, when the store ID of the store A is not included in the advertisement request, the privileged advertisement information and the standard advertisement information of all stores may be transmitted.

Subsequently, the information terminal 100A displays the privileged advertisement of the store A or the standard advertisement of the store A on the display 105 (step S903). Here, the information terminal 100A determines whether the beacon signal corresponding to the store A has been successfully received. If the beacon signal corresponding to the store A has been successfully received, the information terminal 100A may display the privileged advertisement of the store A. On the other hand, if the reception of the beacon signal corresponding to the store A has been failed, the information terminal 100A may display the standard advertisement of the store A on the display 105. The subsequent processing is the same as that in FIG. 14 except in S904, in which the information terminal 100B transmits only the advertisement request to the management server 200.

As described above, according to the third embodiment, since the information terminal 100 determines whether to display the privileged advertisement or the standard advertisement, it is possible to reduce the processing load of the management server 200.

### Modifications

In the first to third embodiments, it is assumed that the user designates a store (step S1801 in FIG. 13). However, the present disclosure is not limited to this, and designation of a store and an advertisement request may be replaced by one operation of starting the business operator X application.

For example, the user instructs the information terminal 100 to start the business operator X application and displays the initial screen G1, and at the same time, the information terminal 100 confirms reception of a beacon signal. The information terminal 100 specifies a store ID corresponding to a device ID from the device ID included in the received beacon signal, and transmits the specified store ID, “beacon reception: successful”, and an advertisement request to the management server 200. If a limited product is detected in the store, the management server 200 may transmit the limited product information to the information terminal 100 so as to display the limited product information as the advertisement display field 17 on the initial screen G1 of the user.

On the contrary to the above case, the user instructs the information terminal 100 to start the business operator X application and displays the initial screen G1, and at the same time, the information terminal 100 confirms reception of a beacon signal and transmits the store ID corresponding to the device ID included in the received beacon signal to the management server 200. If it is detected that the limited product information is not registered in the store corresponding to the received store ID, the management server 200 may transmit the limited product information to the information terminal 100 so as to display the standard advertisement not including the limited product as the advertisement display field 17 of the initial screen G1 of the user.

In such a case, there is an advantage that the user can immediately check the presence or absence of the limited product and the content of the limited product only by starting the business operator X application.

According to the present disclosure, it is possible to provide an information providing method useful in retail businesses such as supermarkets, and the like.

1. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, i) a request for an advertisement corresponding to the store and ii) a first notification indicating that a beacon signal including a device identifier (ID) specifying a beacon signal transmitter disposed in the store has been received from the beacon signal transmitter, the beacon signal being received by the first communication terminal within a reception range of the beacon signal, the store being specified based on the device ID by the first communication terminal having received the beacon signal;
generating, based on the limited product information, the request for the advertisement, and the first notification, privileged advertisement information of the store, the privileged advertisement information including the limited product;
outputting the privileged advertisement information to the first communication terminal;
acquiring, from a third communication terminal of a third user, a request for the advertisement corresponding to the store, the third communication terminal being not within the reception range of the beacon signal; and
outputting, based on the limited product information and the request for the advertisement, standard advertisement information of the store to the third communication terminal, the standard advertisement information not including the limited product.

2. The method according to claim 1, further comprising:
acquiring, from the store terminal, sold-out information indicating that the limited product has been sold out in the store;
acquiring, from a second communication terminal of a second user, i) a request for the advertisement corresponding to the store and ii) a second notification indicating that the beacon signal including the device ID specifying the beacon signal transmitter disposed in the store has been received from the beacon signal transmitter, the beacon signal being received by the second communication terminal within the reception range of the beacon signal, the store being specified based on the device ID by the second communication terminal having received the beacon signal; and
outputting, based on the sold-out information, the request for the advertisement, and the second notification, standard advertisement information of the store to the second communication terminal, the standard advertisement information not including the limited product.

3. (canceled)

4. The method according to claim 1, wherein
a monitor connected to the store terminal is disposed in the store, and
the limited product information is acquired from the store terminal in synchronization with a first instruction to display on the monitor the limited product information, the first instruction being output from the store terminal to the monitor.

5. The method according to claim 2, wherein
a monitor connected to the store terminal is disposed in the store, and
the sold-out information is acquired from the store terminal in synchronization with a second instruction to erase a display of the limited product information from the monitor, the second instruction being output from the store terminal to the monitor.

6. The method according to claim 1, wherein
the time available for sale is shorter than 24 hours.

7. A method for a store management system connected to a store terminal, the method comprising:
acquiring, from the store terminal via a network, limited product information indicating a limited product for which a time available for sale in a store corresponding to the store terminal is limited;
acquiring, from a first communication terminal of a first user via the network, i) a request for an advertisement corresponding to the store and ii) a first notification indicating that a beacon signal including a device ID specifying a beacon signal transmitter disposed in the store has been received from the beacon signal transmitter, the beacon signal being received by the first communication terminal within a reception range of the beacon signal, the store being specified based on the device ID by the first communication terminal having received the beacon signal;
generating, based on the limited product information, privileged advertisement information of the store, the privileged advertisement information including the limited product;
outputting, based on the request for the advertisement and the first notification, the privileged advertisement information to the first communication terminal;
acquiring, from a third communication terminal of a third user, a request for the advertisement corresponding to the store, the third communication terminal being not within the reception range of the beacon signal; and
outputting, based on the limited product information and the request for the advertisement, standard advertisement information of the store to the third communication terminal, the standard advertisement information not including the limited product.

8. The method according to claim 7, further comprising:
acquiring, from the store terminal, sold-out information indicating that the limited product has been sold out in the store;
acquiring, from a second communication terminal of a second user, i) a request for the advertisement corresponding to the store and ii) a second notification indicating that the beacon signal including the device ID specifying the beacon signal transmitter disposed in the store has been received from the beacon signal transmitter, the beacon signal being received by the second communication terminal within the reception range of the beacon signal, the store being specified based on the device ID by the second communication terminal having received the beacon signal; and
outputting, based on the sold-out information, the request for the advertisement, and the second notification, standard advertisement information of the store to the second communication terminal, the standard advertisement information not including the limited product.

9. (canceled)

10. The method according to claim 7, wherein
a monitor connected to the store terminal is disposed in the store, and
the limited product information is acquired from the store terminal in synchronization with a first instruction to display on the monitor the limited product information, the first instruction being output from the store terminal to the monitor.

11. The method according to claim 8, wherein
a monitor connected to the store terminal is disposed in the store, and
the sold-out information is acquired from the store terminal in synchronization with a second instruction to erase a display of the limited product information from the monitor, the second instruction being output from the store terminal to the monitor.

12. The method according to claim 7, wherein
the time available for sale is shorter than 24 hours.

13. A method to be executed in a communication terminal that communicates with a store management system connected to a store terminal, the method comprising:
acquiring, from the store terminal via a network in the store management system, limited product information indicating a limited product for which a time available for sale in a store corresponding to the store terminal is limited;
outputting a request for an advertisement corresponding to a first store to the store management system via the network;
acquiring, in response to the request for the advertisement, i) first advertisement information representing a standard advertisement of the first store and ii) second advertisement information representing a privileged advertisement of the first store, the privileged advertisement including the limited product in the standard advertisement, the second advertisement information being generated using the limited product information in the store management system;
detecting a beacon signal transmitted from a first beacon signal transmitter disposed in the first store; and
if the beacon signal is not detected, displaying the standard advertisement of the store represented by the first advertisement information on a display of the communication terminal, and, if the beacon signal transmitted from the first beacon signal transmitter is detected, displaying the privileged advertisement of the store represented by the second advertisement information on the display of the communication terminal.

14. The method according to claim 13, wherein
the detected beacon signal includes a device ID specifying one beacon signal transmitter that has transmitted the detected beacon signal,
one store in which the one beacon signal transmitter is installed is specified based on the device ID, and
if the specified one store matches the first store, it is determined that the detected beacon signal is transmitted from the first beacon signal transmitter, and the privileged advertisement of the store represented by the second advertisement information is displayed on the display of the communication terminal.

15. The method according to claim 14, wherein
if the specified one store does not match the first store, it is determined that the detected beacon signal is transmitted from a second beacon signal transmitter disposed in a second store other than the first store, and the standard advertisement of the first store represented by the first advertisement information is displayed on the display of the communication terminal.

16. A communication terminal that executes the control method according to claim 13.

17. A recording medium storing a program for causing a computer of the communication terminal to execute the control method according to claim 13.
